(19) United States
(12) Patent Application Publication
(10) Pub. No.: US 2006/0084449 A1
(43) Pub. Date: Apr. 20, 2006

(54) Method and apparatus for evaluating locations according to Feng Shui principles

(75) Inventors: Fan He, Grayslake, IL (US); David J. Briggs, Crystal Lake, IL (US); Jing Li, Beijing (CN)

Correspondence Address: LAW OFFICES OF CHARLES W. BETHARDS, LLP, P.O. BOX 1622, COLLEYVILLE, TX, 76034, US

(73) Assignee: MOTOROLA, INC.

(21) Appl. No.: 10/966,876

(22) Filed: Oct. 15, 2004

(51) Int. Cl. H04Q 7/20

(52) U.S. Cl. 455/457

(57) ABSTRACT

A communication device (112) includes a communications receiver (120), an AM/FM receiver (124), a three-dimensional Hall-effect sensor (226), a digital camera (128), and a GPS receiver (130), which each have multiple uses. In addition to their usual functions, the various capabilities of the respective elements (112, 120, 124, 226, 128, 130) can be used to provide data for evaluating a location in accordance with the principles of Feng Shui. A processor 116 reads values from the devices (112, 120, 124, 126, 128, 130) and uses the values to evaluate a given location in accordance with Feng Shui criteria. An overall Feng Shui value is determined for a given location.

### FIELD OF THE INVENTION

This invention relates in general to devices for taking environmental measurements and more particularly to a device for taking and evaluating environmental measurements according to principles of Feng Shui.

### BACKGROUND OF THE INVENTION

Among known methods of evaluating surroundings is Feng Shui, an ancient Chinese art of creating a harmonious environment. Recently, Feng Shui has increased in popularity in many societies around the world. Feng Shui principles are widely applied in the fields of interior decorating and real estate. Despite the increased popularity of Feng Shui, its complexity detracts ordinary people from using it to improve their overall lifestyle and associated environment.

Handheld electronic devices, such as cellular telephones and personal digital assistants, have also become more prevalent in recent years. Some handheld electronic devices today can include the capability to measure environmental characteristics.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a communication device in a communications system;

FIG. 2 is an exemplary block diagram illustrating a three-dimensional Hall-effect sensor.

FIG. 3 is a flow chart illustrating an exemplary operation performed by the communication device of FIG. 1 to evaluate a location;

FIG. 4 is a flow chart illustrating an exemplary operation for processing of an image in preparation for a color analysis;

FIG. 5 is an exemplary table of criteria for Feng Shui evaluation; and

FIG. 6 is a diagram illustrating the enhancement cycle of Feng Shui.

### DETAILED DESCRIPTION

The present disclosure concerns communications devices that operate with systems providing services such as voice and data communications services to the communications devices or units. The communications devices, often referred to as subscriber devices or handsets, can be, for example, cellular telephones, wireless messaging devices, personal digital assistants, or equivalents thereof.

More particularly various inventive concepts and principles and combinations thereof are advantageously employed to provide a method and apparatus for evaluating locations according to Feng Shui principles within a communication device.

The communication devices that are of particular interest are those that provide or facilitate voice communication services or data or messaging services on systems, such as conventional two way systems and devices, various cellular phone systems including analog and digital cellular, CDMA (code division multiple access) and variants thereof, GSM (Global System for Mobile communications), GPRS (General Packet Radio System), 2.5 G and 3G systems such as UMTS (Universal Mobile Telecommunication Service) systems, integrated digital enhanced networks, and variants or evolutions thereof. Similarly, the communication systems and devices can include LAN (local area network) systems that employ anyone of a number of access technologies and networking protocols, such as TCP/IP (Transmission Control Protocol/Internet Protocol) or any other packet structures.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, upper and lower and the like are used solely to distinguish one from another entity or action without necessarily requiring or implying any actual such relationship or order between such entities or actions.

The terms “a” or “an” as used herein are defined as one or more than one. The term “plurality” as used herein is defined as two or more than two. The term “another” as used herein is defined as at least a second or more. The terms “including,” “having” and “has” as used herein are defined as comprising (i.e., open language). The term “coupled” as used herein is defined as connected, although not necessarily directly and not necessarily mechanically.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

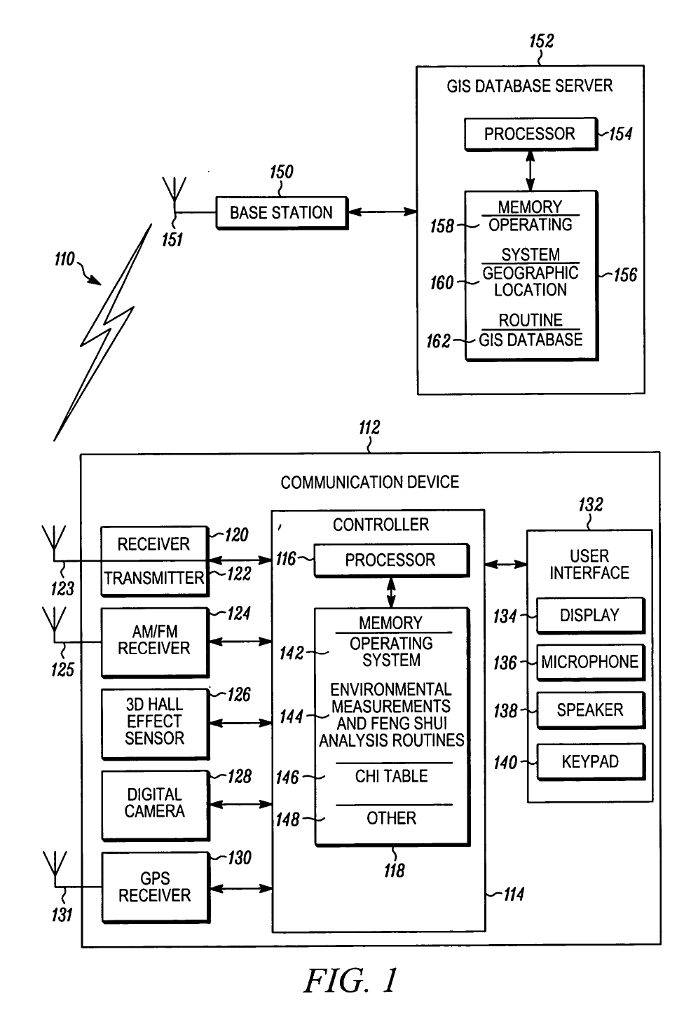

Referring to FIG. 1, a communication system 110 including a communication device 112 which communicates with a base station 150 is illustrated. The communication device 112, for example, can be a mobile device such as a mobile telephone, personal digital assistant, or the like. The communication device 112 communicates wirelessly with the base station 150 through a conventional communication network such as one of those mentioned or described previously herein. Preferably, in addition to its traditional functions (a telephone, personal digital assistant, or the like), the communication device 112 measures environmental characteristics and determines a positive, neutral, or negative Feng Shui value based on the environmental characteristics as described in more detail below. In one embodiment, the communication device 112 utilizes capabilities that may already be incorporated for other functionality to measure the environmental characteristics as will be further described herein.

The communication device 112 includes a controller 114. The controller 114 includes a processor 116 and a memory 118. The memory 118 includes a first section 142 for storing an operating system and one or more device drivers (not shown), a second section 144 for storing algorithms or other instructional information for measuring environmental characteristics and for performing analysis based on Feng Shui principles, a third section 146 for storing a chi table, and a fourth section 148 for storing other data or programs used by the processor 116 to operate the communication device 112.

Coupled to the controller 114 are a receiver 120 and a transmitter 122. The receiver 120 and the transmitter 122 are coupled to an antenna 123 (or alternatively a transceiver (not shown) for performing the functionality of the receiver and the transmitter). The receiver 120 and the transmitter 122 perform transmission and reception of various communications with the base station 150 using a common communication protocol as is well known in the art.

The receiver 120 can be used to measure the proximity of a given location to the nearest communications tower, e.g. the tower with the antenna 151 for base station 150. For example, cellular telephone receivers can detect a bit error rate of an incoming signal. The bit error rate is an indication of signal strength, which translates to an indication of the distance between the communication device 112 and the nearest communications tower. The distance from a location to the nearest communications tower can influence the Feng Shui evaluation of a location, as discussed below.

In one embodiment, an AM/FM (amplitude modulation/frequency modulation) receiver 124 of a known type is coupled to the controller 114. An antenna 125 is coupled to the AM/FM receiver 124. The AM/FM receiver 124 allows the user of the communication device 112 to listen to AM and FM radio stations in a conventional manner. Further, the AM/FM receiver 124 provides the capability to measure in a known manner the power of radio transmissions on the AM and FM bands for use in the Feng Shui evaluation as described further below.

In one embodiment, a three-dimensional Hall-effect sensor 226 is coupled to the controller 114. The Hall-effect sensor 226 is a known three-dimensional sensor for measuring the strength of electromagnetic fields. The Hall-effect sensor 226 can be a combination of a two-dimensional Hall-effect sensor 226 and a one-dimensional sensor to form a three-dimensional Hall-effect sensor in a manner known to those skilled in the art. The electromagnetic field strength at a given location can be used in evaluating locations according to the principles of Feng Shui, which is discussed in more detail below.

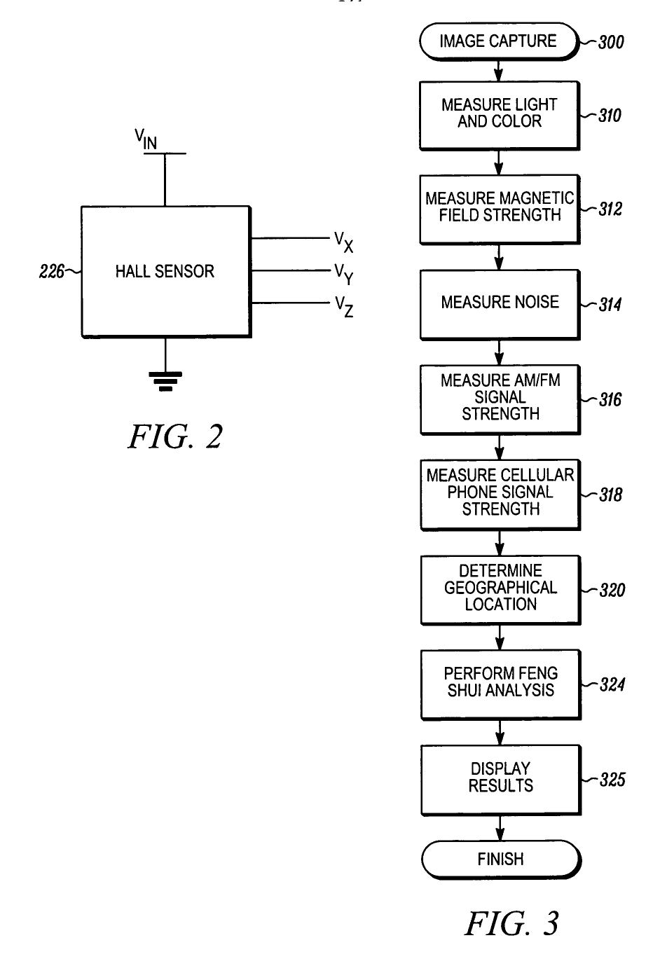

As shown in FIG. 2, the Hall-effect sensor 226 has three output signals, which correspond to x, y, and z-axes. That is, the Hall-effect sensor 226 has an x-axis output voltage signal Vₓ, a y-axis output voltage signal V_{y} and a z-axis output voltage signal V_{z}. The Hall-effect sensor can be arranged on a circuit board of the communication device 112 such that the three axes correspond with axes of the housing (not shown) of the communication device 112. Thus, a user can hold the communication device 112 such that a display 134 is parallel to the ground, and the z-axis will be perpendicular to the ground and to the display 134, and the x-axis and the y-axis will correspond to the two axes of the display, for example.

The Hall-effect sensor 226 can be used to form a compass. Only two of the outputs of the Hall-effect sensor 226 are needed to perform the function of a compass. That is, the x-axis and y-axis outputs are used, but the z-axis output is not used. When using the compass function, a user holds the communication device 112 so that the display 134 is parallel to the ground and so that the top of the communication device 112 is directed towards a main wall of a house, for example. That is, when standing inside the house, a line from the top of the communication device 112 to the main wall of the house is perpendicular to the front of the house. Then, the user selects an icon, for example, that causes the processor 116 to store magnetic field information from the Hall-effect sensor 226 in the memory 118. From the stored magnetic field information, the processor 116 can determine the geographic direction in which the main wall of the house faces in a manner known to those skilled in the art. In the Feng Shui evaluation of this embodiment, the main wall of a house is the wall in which the most windows are located.

Referring back to FIG. 1, a digital camera 128 of a known type is coupled to the controller 114. The digital camera can be used in a traditional manner to allow the user of the communication device 112 to take pictures, store pictures, and send pictures to others in a conventional manner, and further the digital camera 128 can also be used for Feng Shui analysis to evaluate colors of an image, which is discussed in more detail below.

In one embodiment, a GPS receiver 130 of a known type is coupled to the controller 114. An antenna 131 is coupled to the GPS receiver 130 for receiving signals from GPS satellites in a known manner. The GPS receiver 130 can determine the geographic location of the communication device 112 and provides data representing the geographic location of the communication device 112 to the controller 114. It will be appreciated that other location tracking methods and devices, such as triangulation or identification information (cell site IDs) associated with known locations, can be utilized by the communication device 112 to determine its geographic location in accordance with the present invention. Along with other data, geographical location can be used by the communication device 112 in performing a Feng Shui analysis of a given location, as discussed in more detail below.

A user interface 132 is also coupled to the controller 114. The user interface 132 can include a display 134, which can be, for example, a QCIF display (Quarter Common Interchange Format Display). The user interface 132 further includes a microphone 136 of the type conventionally used in cellular telephones and the like for detecting audio such as spoken words. The user interface 132 further can include a conventional speaker 138 and/or a conventional keypad 140.

The base station 150 is coupled to a station antenna 151 for wirelessly communicating within the communication system, for example with the communication device 112. The base station 150 includes a transmitter and receiver (not shown) or alternatively a transceiver (not shown) for such communication. In the illustrated embodiment, the base station 150 is coupled to a GIS (geographic information systems) database server 152. The GIS database is a known database of geographic information maintained by the USGS (United States Geological Survey). The GIS database server 152 provides access to the GIS database. Therefore, through the base station 150, the communication device 112 can wirelessly access the GIS database.

The GIS database server 152 can include a GIS server processor 154 and a GIS server memory 156. The GIS server memory 156 can include at least a first server section 158 for storing an operating system, a second server section 160 for storing a routine for retrieving geographic information relating to a given location and for sending that information to the communication device 112 when necessary, e.g. when requested. Also, the GIS server memory 156 can include a third server section 162 for storing the GIS database.

FIG. 3 shows an exemplary process for performing a Feng Shui analysis of a given location/environment. Initially, at 300, an image is captured of a location/environment for which a Feng Shui analysis is desired (for example: with the digital camera 128). The image can be stored in the memory 118 of the controller 114 for further processing as desired.

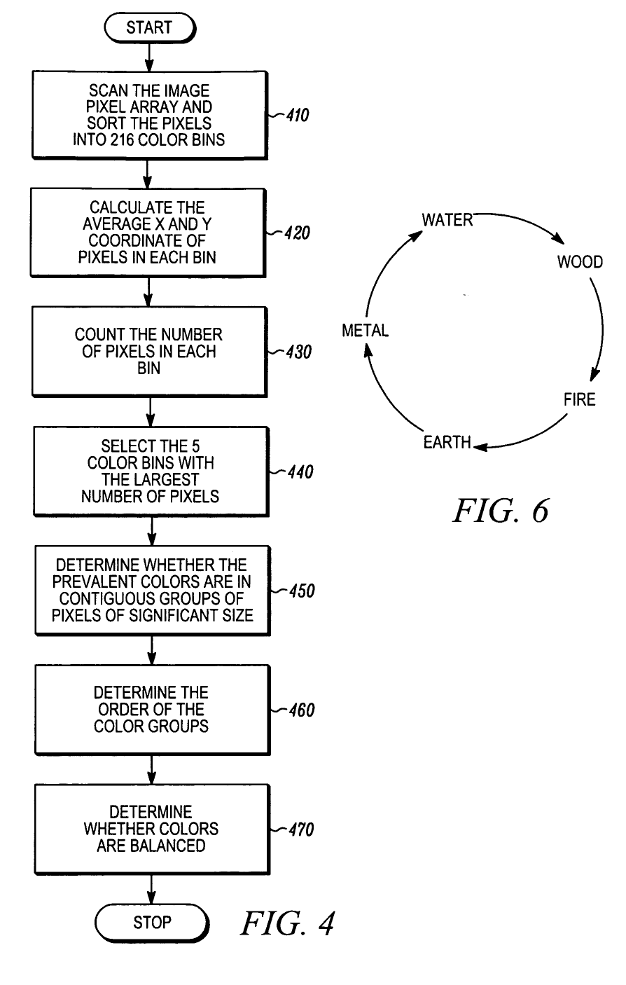

The image processing performed at 300 is shown in more detail in the flow chart of FIG. 4. In FIG. 4, at 410, the digital camera pixel array is scanned and sorted into, for example, two-hundred sixteen (216) color bins. Then, at 420, the average x-coordinate and average y-coordinate for each of the two-hundred sixteen color bins is determined. Then, at 430, the number of pixels in each bin is determined. At 440, the five color bins with the largest number of pixels is determined. Thus, at 440, the most prevalent colors are determined. At 450, it is determined which colors tend to occur in continuous pixel groups of significant size. Then, at 460, the order of the significant color groups is determined. That is, the position of each significant color group is determined relative to the others.

Finally, at 470, the processor 116 determines whether the colors are balanced. Thus, for example, the processor 116 determines whether the number of red pixels, blue pixels, and green pixels are approximately equal in the image. An evaluation of the color order and balance is performed in the Feng Shui analysis at 324 of FIG. 3, which is discussed further below. The details of the processing of the pixels in the image to determine what colors occur in significant pixel groups and in what order the significant pixel groups occur can be performed by a programmer of ordinary skill and will not be discussed.

Referring back to FIG. 3, at 312, the magnetic strength of the location of the communication device 112 is measured with the three-dimensional Hall-effect sensor 226. The Hall-effect sensor 226 yields three voltage signals Vₓ, V_{y}, and V_{z}, as shown in FIG. 2. Each voltage signal is proportional to and representative of the magnetic field intensity of the corresponding axis. A total magnetic field intensity is calculated by the processor 116 according to the equation B_{T}=[B_{X}²+B_{Y}²+B_{Z}²]^{1/2} where B_{T} is the total magnetic field intensity, B_{X} is the magnetic field intensity along the x-axis, B_{Y} is the magnetic field intensity along the y-axis, and B_{Z} is the magnetic field intensity along the z-axis. The units of the magnetic field intensity are Gauss in the illustrated embodiment; however other units can be used.

The Hall-effect sensor 226 can also be used as a compass at 312 of FIG. 3. That is, in addition to measuring overall magnetic field strength, which does not require the communication device 112 to be pointed in a particular direction, a compass reading can be taken by the communication device 112 when the communication device 112 is being pointed towards, for example, the main wall of a house.

The noise level of the location can be measured with the microphone 136 at 314 of FIG. 3. That is, a signal from the microphone 136 is processed by the processor 116 to determine a noise level. The units of noise in the illustrated embodiment are decibals; however, other units can be used.

At 316, the signal strength of the AM/FM radio is measured. That is, in two separate measurements, the signal strength of the AM signal is detected and the signal strength of the FM signal is detected. Signal strength information is typically provided by accessing an automatic gain control register (not shown) associated with the receiver 124 in the communication device 112. The signal strength of the AM and FM signals can be used as an indicator of the distance between the communication device 112 and the nearest AM or FM transmission tower.

The signal strength of a cellular phone signal is measured by the receiver 120 in units of dBm/m² at 318. As mentioned above, the signal strength can be determined by accessing the bit error rate or the like of the receiver 120.

At 320, the geographical location of the communication device 112 is determined, for example, by using the GPS receiver 130. Once the location is known, the location is sent wirelessly through a communication network to the base station 150 and further to the GIS database server 152. The GIS database server 152 provides information concerning the surroundings of the location. For example, the distance between the current location of the communication device 112 and undesirable sites such as major airports, landfills, and factories is determined. The distances to the undesirable sites are determined from data provided by the GIS database 162.

Processing of data from the GIS database to determine the distances of interest can be performed in the GIS database server or by the processor 116 in the communication device 112. The Feng Shui analysis of this embodiment, which is described below, requires only the distances of interest and not other information such as the actual location of the airports, landfills or factories. Thus, if it is desired to reduce the load on the processor 116 and to minimize the memory requirements of the communication device 112, it is advantageous to perform most of the geographical processing in the GIS database server 152 and to transmit only the distance data of the undesirable sites to the communication device 112 after the communication device 112 transmits its current location to the base station 150. Routines to calculate distances between locations using geographical information including GPS data can be created by programmers of ordinary skill and are thus not described herein.

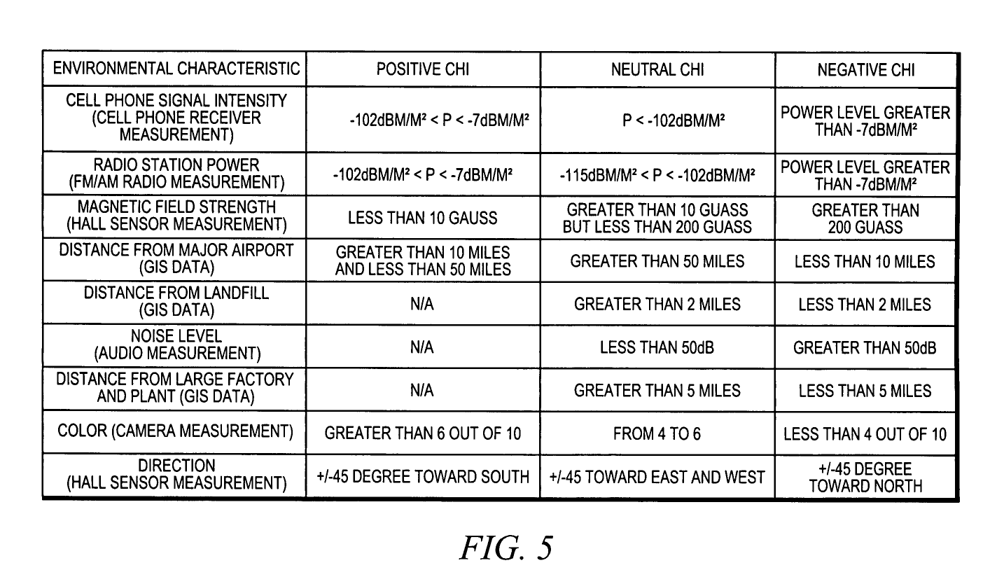

Feng Shui analysis is performed at 324. The Feng Shui analysis, for example, includes determining whether a particular measured characteristic is positive, neutral, or negative according to Feng Shui principles. Chi can be considered a measurement of Feng Shui. FIG. 5, for example, is a table illustrating criteria which can be set for positive, neutral, and negative chi for each environmental characteristic according to the principles of Feng Shui.

Referring back to FIG. 3, at 324, the processor 116 compares each measured data with the corresponding criteria of a table (such as Table 5) to determine whether each measurement reflects positive, neutral, or negative chi. The criteria are somewhat subjective; therefore, the criteria limits indicated in the table of FIG. 5 can be changed as long as principles of Feng Shui are followed. For example, a point system can be used to determine an overall Feng Shui rating. That is, each characteristic that is rated as having positive chi contributes one point to a total. A characteristic having neutral chi contributes no points, and a characteristic having negative chi deducts one point from the total. Then, for example, an average or total can be taken to determine an overall rating of the given location.

The direction in which the main wall of a house faces influences the Feng Shui evaluation. Thus, for example, a point can deducted from a score if the main wall faces west. Two points can be deducted if the main wall faces north. No points are added or deducted if the main wall faces northeast. One point can be added to the score if the main wall faces east or southeast. Finally two points can be added if the main wall faces south. The final score can be used to determine a positive, neutral or negative rating.

Alternatively, as shown in the table of FIG. 5, a positive chi rating can be given when the main wall faces within a forty-five degree angle of due south. A neutral chi rating can be given when the main wall faces within a forty-five degree angle of due east or west. Finally, a negative chi rating can be given when the main wall faces within a forty-five degree angle of due north. Other similar scoring criteria can be used as long as the basic principles of Feng Shui are followed.

With regard to the image captured (for example: a digital image taken with the camera 128) at 300 of FIG. 3, in the table of FIG. 5, criteria are shown for determining a chi value of the image. In analyzing the image, the balance of color and the order of the colors of the image are analyzed according to Feng Shui principals to indicate whether the order of the colors is undesirable or favorable. As for the color balance, the processor 116 determines whether average values of the red pixels, the green pixels, and blue pixels are approximately equal. That is, each pixel has a value, for example, between zero and 255. These values are averaged for each of the red, green and blue pixels. If the averages are approximately equal, the color is balanced. If not, the color is not balanced.

In Feng Shui, there is a desirable order of colors. The most favorable order of colors is that corresponding to the enhancement cycle, which is a cycle well known in Feng Shui. The enhancement cycle is shown in FIG. 6. The colors associated with the various parts of the enhancement cycle are known. Colors such as red, orange, burgundy, pink, purple are associated with fire. Colors such as brown, yellow, off-white, gray are associated with earth. Colors such as white, silver, gold, bronze are associated with metal. Colors such as black and blue are associated with water. Colors such as green and jade are associated with wood. When colors occur in the order of the enhancement cycle of FIG. 6, the Feng Shui rating of that image will be high.

In an exemplary process of evaluating the captured image, the image can be given ten points initially. Points can be added to the total for desirable features and deducted from the total for undesirable features. For example, with regard to color balance, an average can be taken of the average value of the red pixels, the average value of the green pixels and the average value of the blue pixels. In other words, the total of the three (red, green and blue) average pixel values is divided by three to find an overall average. If each of the average values of the red pixels, green pixels, and blue pixels is within plus or minus 50 percent of the overall average, then three points can be added to the score. One point is deducted for each of the color averages that is outside the range of plus or minus 50 percent of the overall average.

With respect to color order, an undesirable color order will reduce the number of points by one, for example. Also, if a color is missing from those that exist in the enhancement cycle, one point can be deducted. The resulting point value is used to rate the image as having positive, neutral or negative chi, where a high point value corresponds to positive chi and a low point value corresponds to negative chi, as indicated in the table of FIG. 5. Finally, an overall chi value is determined based on all the individual chi ratings.

Referring back to FIG. 3, at 325, the communication device 112 displays the results of the Feng Shui analysis on the display 134. The user can select whether to have the results displayed in detail or in summary. For example, a summary of the results can simply be one indication of positive, neutral, or negative chi. A detailed display of the results can show the chi rating (positive, negative, or neutral) for each of the measured characteristics.

Further, the user can select an option to have a Chinese compass, known as a lo pan, displayed on the display 134. A compass can be displayed using two outputs of the Hall-effect sensor 226 in a manner well known to those skilled in the art. Points on a Chinese lo pan correspond to points on a conventional compass; however, the lo pan has twenty-four directions. Therefore, a Chinese lo pan can be displayed in the same manner that conventional compasses are displayed, for example, on watches and other portable electronic devices. The Chinese lo pan can be used for further Feng Shui analysis.

The apparatus and methods discussed above and the inventive principles thereof are intended to and will alleviate short comings of conventional wireless communication units. Using these principles of environmental evaluation will contribute to user satisfaction. It is expected that one of ordinary skill given the above described principles, concepts and examples will be able to implement other alternative procedures and constructions that offer the same or similar benefits. It is anticipated that the claims below cover many such other procedures and constructions. For example, environmental characteristics other than those specifically mentioned can be measured and used in the Feng Shui analysis. Also, characteristics of the image taken by the digital camera 128 other than the color order and balance can be evaluated. In addition, the order of the measurements shown in FIG. 3 is not critical and can be changed.

The disclosure is intended to explain how to fashion and use various embodiments in accordance with the invention rather than to limit the true, intended and fair scope and spirit thereof. The forgoing description is not intended to be exhaustive or to limit the invention to the precise form disclosed. Modifications or variations are possible in light of the above teachings. The embodiments were chosen and described to illustrate the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An electronic apparatus comprising:
a sensor adapted to electronically sense at least one environmental characteristic of the location of the electronic apparatus;
a memory having storage locations for storing association information between values of one or more environmental characteristics and one or more Feng Shui values;
a controller, which is coupled to the sensor and to the memory, that evaluates the at least one environmental characteristic received from the sensor using the stored association information.

2. The electronic apparatus according to claim 1 further comprising:
a display coupled to the controller, wherein the display displays an image representing a result of the evaluation.

3. The electronic apparatus according to claim 1, wherein the sensor comprises a digital camera for capturing an image, and further wherein the at least one environmental characteristic includes an arrangement of colors in the captured image.

4. The electronic apparatus according to claim 1, wherein the sensor comprises a Hall effect sensor, and further wherein the at least one environmental characteristic includes a strength of an electromagnetic field sensed by the Hall effect sensor.

5. The electronic apparatus according to claim 1, wherein the sensor comprises a location capturing block, and further wherein the at least one environmental characteristic includes a geographic location captured by the location capturing block.

6. The electronic apparatus according to claim 5, wherein the location capturing block comprises a GPS receiver.

7. The electronic apparatus according to claim 5, wherein the location capturing device is communicatively coupled to a geographical database for determining the geographic location.

8. The electronic apparatus according to claim 1, wherein the sensor comprises a radio receiver, and further wherein the at least one environmental characteristic comprises a location of the radio receiver based on the strength of a radio signal received by the radio receiver.

9. The electronic apparatus according to claim 1, wherein the sensor comprises a cellular telephone receiver, and further wherein the at least one environmental characteristic comprises a location of the cellular telephone receiver based on a bit error rate of a signal received by the cellular telephone receiver.

10. The electronic apparatus according to claim 1, wherein the sensor comprises a microphone, and further wherein the at least one environmental characteristic comprises an ambient noise level detected by the microphone.

11. The electronic apparatus according to claim 1, wherein the electronic apparatus comprises a mobile telephone.

12. A wireless communication device comprising:
an apparatus for transmitting and receiving radio signals;
a sensor that electronically senses a characteristic of the environment surrounding the wireless communication device;
a controller that is coupled to the sensor, wherein the controller reads a signal from the sensor and performs a Feng Shui evaluation based on the signal;
a memory that is coupled to the controller, wherein the memory stores information representing a relationship between values of the characteristic and Feng Shui values and wherein the controller uses the information to perform the evaluation; and
a display that is coupled to the controller, wherein the display displays an image representing a result of the evaluation.

13. The wireless communication device according to claim 12, wherein the sensor comprises a digital camera and the controller determines a Feng Shui value of an image taken by the digital camera based on an arrangement of colors in the image.

14. The wireless communication device according to claim 12, wherein the sensor comprises a Hall effect sensor and the controller determines a Feng Shui value of a location of the Hall effect sensor based on a strength of an electromagnetic field sensed by the Hall effect sensor.

15. The wireless communication device according to claim 12, wherein the sensor comprises a GPS receiver and the controller determines a Feng Shui value of a geographic location of the GPS receiver by accessing a geographical database to retrieve geographic information about the geographic location.

16. The wireless communication device according to claim 12, wherein the apparatus for transmitting and receiving radio signals includes a radio receiver and the controller determines a Feng Shui value of a location of the radio receiver based on a strength of a radio signal received by the radio receiver.

17. The wireless communication device according to claim 12, wherein the apparatus for transmitting and receiving radio signals includes a cellular telephone receiver and the controller determines a Feng Shui value of a location of the wireless communication device based on an error rate of a signal received by the cellular telephone receiver.

18. The apparatus according to claim 12, wherein the wireless communication device is a mobile telephone.

19. A method of Feng Shui evaluation of a location, wherein the method comprises:
associating values of one or more environmental characteristics and one or more Feng Shui values to provide associations;
storing the associations;
sensing an environmental characteristic; and
performing an evaluation based on the environmental characteristic and the associations as stored.

20. The method according to claim 19, further comprising displaying an image representing a result of the evaluation.

21. The method of claim 19, wherein the sensing comprises:
receiving a GPS signal, and wherein the performing the evaluation includes:
determining a geographical location based on the GPS signal;
accessing a geographical database to determine geographical features in a vicinity of the geographical location; and
determining a Feng Shui value of the geographical location based on the geographical features and the associations as stored.

22. The method of claim 19, wherein the sensing comprises capturing a digital image of the location, and wherein the performing the evaluation comprises analyzing one or more colors in the digital image to determine a Feng Shui value of the digital image.

23. The method of claim 19, wherein the sensing comprises sensing an electromagnetic field of the location, and wherein the performing the evaluation includes determining a Feng Shui value of the location based on the electromagnetic field and the associations as stored.
